(19) United States
(12) Patent Application Publication
(10) Pub. No.: US 2003/0105915 A1
(43) Pub. Date: Jun. 5, 2003

(54) Address correcting method and device for a simultaneous dynamic random access memory module

(76) Inventor: Shin-Husiung Lien, Taoyuan (TW)

Correspondence Address: OPTIMUM CARE INTERNATIONAL TECH. INC., P.O. Box No.6-57, Chung-Ho, Taipei, 235, TW

(21) Appl. No.: 09/996,723

(22) Filed: Nov. 30, 2001

(51) Int. Cl. G06F 12/00

(52) U.S. Cl. 711/105

(57) ABSTRACT

The present invention relates to an address correcting method and device for a simultaneous dynamic random access memory module using the nature of a column/row address to enable the computer to take the capacity of the simultaneous dynamic random access memory module as a higher capacity thereby to enhance the business value of the simultaneous dynamic random access memory module; in addition, by setting an address line of the simultaneous dynamic random access memory module as a specific value, such as 1 or 0, to make half of the undamaged and useable capacity of an undesirable simultaneous dynamic random access memory module be utilized efficiently thereby to reduce the undesired rate of the simultaneous dynamic random access memory module so as to enhance the usability of the simultaneous dynamic random access memory module with high industrial utilization.

### BACKGROUND OF THE INVENTION

1) Field of the Invention

The present invention relates to an address correcting method and device for a simultaneous dynamic random access memory module, more specifically, an address correcting method and device uses the correction of the column/row locations of a simultaneous dynamic random access memory module to make the motherboard take the said module as a memory module of high capacity, or sets an address line of the simultaneous dynamic random access memory module as a fixed value so as to enable an undesirable simultaneous dynamic random access memory module with half desired memory capacity to utilize the said half desired memory capacity, thereby to reduce the undesired rate of the simultaneous dynamic random access memory module.

2) Description of the Prior Art

Accordingly, the dynamic random access memory (DRAM) has been developed very quickly and has already surpassed the adaptability designed for the present motherboard, for example, the simultaneous dynamic random access memory of 32MX4 has the actual capacity of 256M, but the present motherboard, such as Intel 815 Chipset can only identify and apply half of the capacity of the said simultaneous dynamic random access memory of 32MX4, that is 128M; therefore, the sale cost of the expansive simultaneous dynamic random access memory of 32MX4 is tremendously reduced and the device is also wasted; furthermore, the manufacturing cost of the simultaneous dynamic random access memory is quiet high, if the desired portion of the simultaneous dynamic random access memory with at least half of the desired memory capacity can be utilized, then the undesired rate of the simultaneous dynamic random access memory can be reduced and the industrial utilization will be increased.

### SUMMARY OF THE INVENTION

In order to solve the mentioned shortcomings, the inventor of the present invention provides an address correcting method and device for a simultaneous dynamic random access memory module to change the nature of a specific column/row address to be identified by the motherboard as the simultaneous dynamic random access memory module with a higher level capacity so as to fully utilize all of the capacity of the said simultaneous dynamic random access memory, thereby to enhance the economic efficiency and industrial utilization.

Setting a column/row address line of a simultaneous dynamic random access memory with at least half desired capacity as a fixed signal value enables the utilization of half of the memory capable of passing the said set signal value so as to increase the preferred economy and industrial utilization.

The detail composition and implementary method are indicated in the brief description of the drawings below followed by the detailed description of the preferred embodiment. However, the said exemplary embodiment is not the absolute limitation for the complete composition of the present invention; the scope of the present invention should be able to derive other changes, modifications and partial alternations from the scope of the patent application; those portions should be included within the scope of the present invention.

### BRIEF DESCRIPTION OF THE DRAWINGS

FIG. 1 is a block diagram of the first implementary composition of the present invention.

FIG. 2 is a schematic drawing of the signal conditions of the first implementary status of the present invention.

FIG. 3 is a block diagram of the composition of a column/row address setting equipment of a simultaneous dynamic random access memory module of the second implementary status of the present invention.

FIG. 4 is a signal diagram of the simultaneous dynamic random access memory module of the second implementary status of the present invention.

### DETAILED DESCRIPTION OF THE PREFERRED EMBODIMENTS

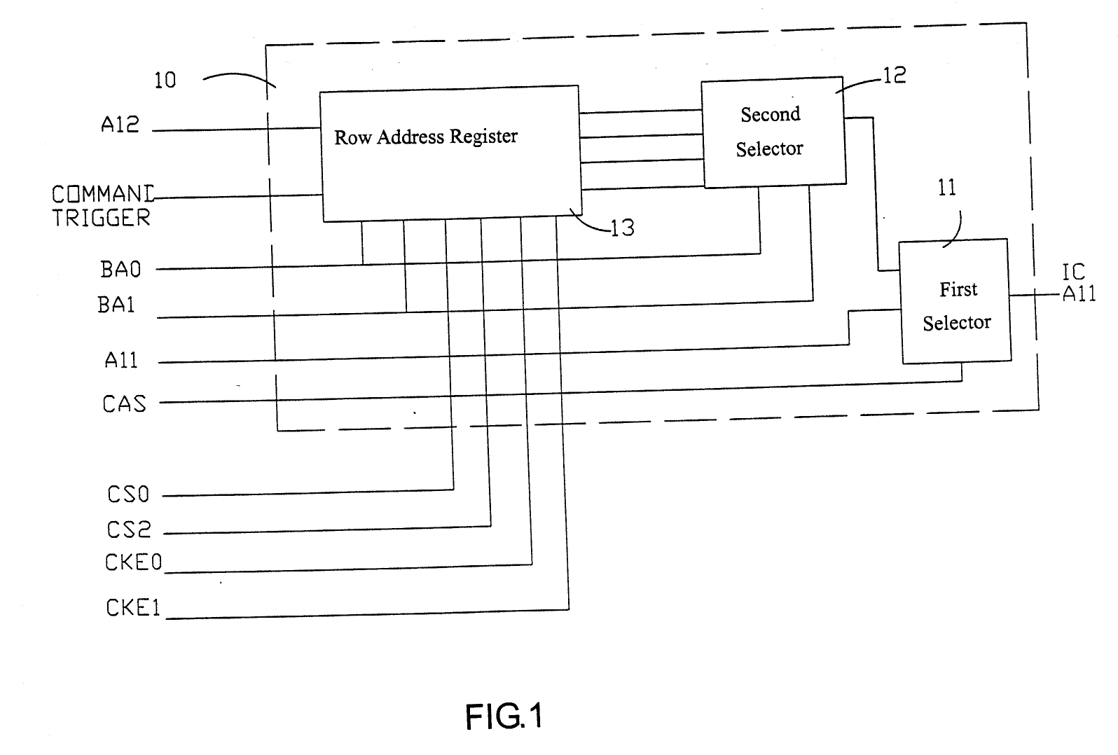

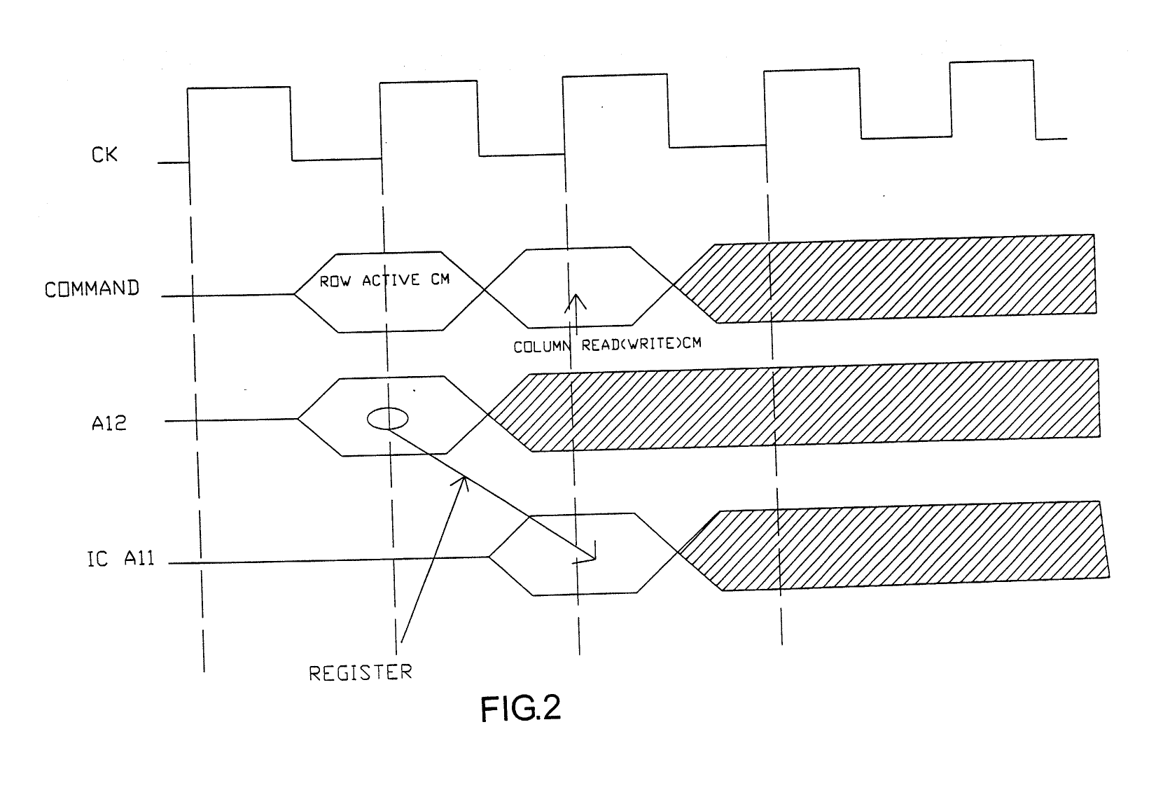

FIG. 1 is the block diagram of the first implementary composition of the present invention and FIG. 2 is the wave form diagram of the said module.

First the nature of a simultaneous dynamic random access memory will be described. For example, the difference between the memory module of 32MX4 with the capacity of 256M and the memory module of 32MX8 with the same capacity is listed as following:

| | 32MX4 | 32MX8 |
|---|---|---|
| Row Address | A0 ˜ A11 | A0 ˜ A12 |
| Column Address | A0 ˜ A9, A11 | A0 ˜ A9 |

As shown in this list, 32MX8 has one row address line A12 than 32MX4 while 32MX4 has one column address line A11 than 32MX8; the present invention converts the column address A11 to row address A12 to make the motherboard take 32MX4 DRAM as a 32MX8 DRAM thereby to enable the motherboard to apply all of the capacity of 32MX4 DRAM, that is the capacity of 256M; the method of the embodied device for execution, as shown in FIG. 1, mainly has a column/row address converting unit (10) connected onto the column address line A11 of the memory module for converting the column address A11 signal to the row address A12 signal; in the present invention, the said column/row address converting unit (10) comprises a first selector (11) with the input end connected onto the column address line A11 of the said memory module; a second selector is based on the output signal of the first selector (11) and cooperates with the signal of the motherboard to generate 4 sets of row address signals; a row address register (13) for registering the row address signal output from the second selector (12) to facilitate the output end thereof to increase a virtual row address line A12; wherein the said first selector (11) is comprised by a two-to-one multiplexer controlled and changed by a CAS signal sent from the motherboard; the second selector (12) is comprised by a four-to-one multiplexer controlled by BA0 and BA1 signals sent from the motherboard to generate four sets of address signals to be sent to the row address register (13); the row address register (13) respectively connects with the signals of BA0, BA1, CAS, CS0, CS2, CKE0, CKE2, et cetera, to facilitate the control of the motherboard; after being converted and processed, a virtual row address line A12 is composed at the output end of the row address register (13) to enable the motherboard to take the memory module of 32MX4 DRAM as a memory of 32MX8 DRAM; the work timing of the said column-row converting unit (10) is shown in FIG. 2.

For the method of embodied implementation, the said column/row converting unit (10) can be made as an ASIC or a PLD.

Therefore, the present invention, based on the differential specialty between the memory module of 32MX4 DRAM and the memory module of 32MX8 DRAM, converts the column address A11 to a row address so as to make the motherboard in detecting the memory module judge the capacity thereof as 256M, thereby, the application of the memory module of 32MX4 DRAM can be returned to the actual 256M for fully utilizing the DRAM sources.

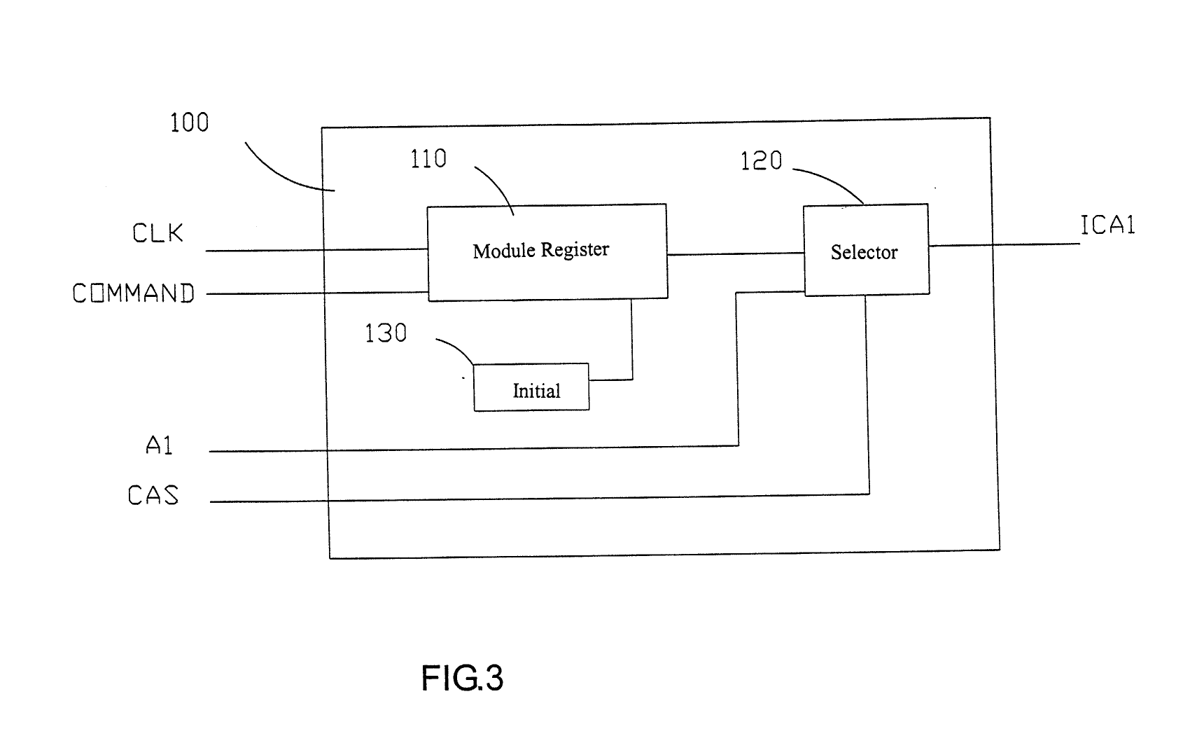

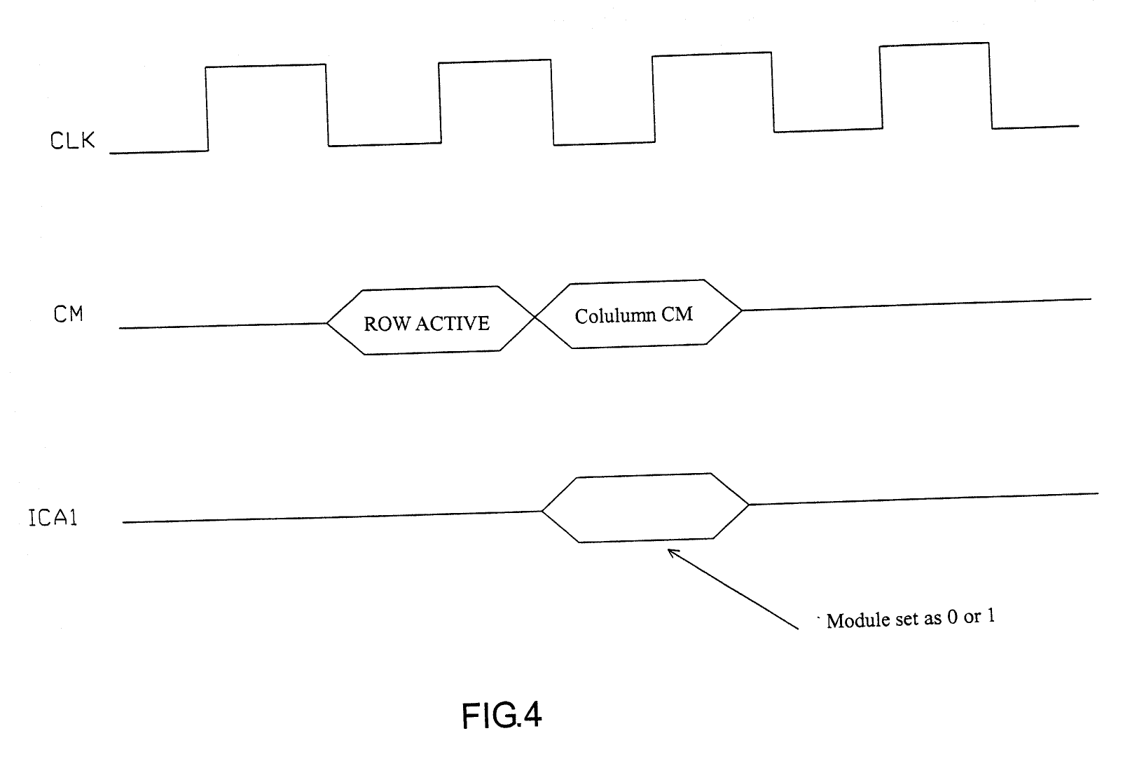

Referring to FIGS. 3 and 4 of another exemplary embodiment of the present invention, wherein FIG. 3 is a block diagram of the composed memory module of the present invention and FIG. 4 is the wave form diagram of the circuits of FIG. 3; as shown in FIGS. 3 and 4, a column address setting equipment (100) includes an initial (130), a module register (110) and a selector (120); wherein the selected column address line A1 connects to the selector (120); the said selector (120) is a two-to-one multiplexer capable of setting the column address CAS as 0 or 1, then providing the portion passed this setting to the motherboard for utilization; wherein the said 0 or 1 value is predetermined to make the said module only available to be utilized by a specific half portion of the said module; therefore, the simultaneous dynamic random access memory module of the present invention can be divided into two sets, one set only uses the portion to be used by the set 0, the other set only uses the portion to be used by the set 1; the portion shown in the Figures is of column address A1.

In summation of the foregoing sections, the first embodiment of the present invention improves the situation of the motherboard being unable to identify all of the capacity to an able one, therefore, the utilization of the motherboard of the capacity of the simultaneous dynamic random access memory can be extended to the maximum to increase the industrial utilization; the second embodiment of the present invention can be manufactured into two elements, one is provided to be used by a module set as 0, another is provided to be used by a module set as 1; therefore, the utilization rate of the undesired is enhanced and the industrial cost is reduced; being a practical invention, the present invention is hereby submitted to the patent bureau for review and the granting of the commensurate patent rights.

The previous descriptions, diagrams and specific structures are only the preferred embodiments for dilating the spirit of the present invention; any appropriate change or adjustment made according to the spirit of the patent scope is acceptable; however, those changes and adjustments should be included in the rights and opinions of the present invention.

1. An address correcting method and device for a simultaneous dynamic random access memory module converts a specific column address of the memory module to an extra row address to be installed onto the motherboard and be identified as a memory module with higher capacity thereby to reflect the actual capacity of the memory module.

2. An address correcting method and device for a simultaneous dynamic random access memory module according to claim 1, wherein the said memory module is of 32MX4 DRAM and the column address A11 thereof is converted to a virtual row address A12.

3. An address correcting method and device for a simultaneous dynamic random access memory module has a column/row address converting unit, the unit comprises a first selector with the input end connected onto the column address line A11 to be converted on the said memory module, a second selector is based on the output signal of the first selector and cooperates with the signal of the motherboard to generate four sets of row address signals, a row address register for registering the row address signal output from the second selector; the output end thereof is increased by a virtual row address line A12.

4. An address correcting method and device for a simultaneous dynamic random access memory module according to claim 3, wherein the first selector is comprised by a two-to-one multiplexer.

5. An address correcting method and device for a simultaneous dynamic random access memory module according to claim 3, wherein the second selector is comprised by a four-to-one multiplexer.

6. An address correcting method on and device for a simultaneous dynamic random access memory module according to claim 1, wherein the said column/row address converting unit is comprised by a programmable logic circuit.

7. An address correcting method and device for a simultaneous dynamic random access memory sets an address line as 1 or 0 to allow the motherboard only to operate half of the memory passed the set of the said address thereby to reduce the memory capacity to half the size and to enable the originally undesired simultaneous dynamic random access memory to be applied to the motherboard.

8. An address correcting method and device for a simultaneous dynamic random access memory includes an initial with the output end connected to a module register; a module register receives the setting from the said initial for registering the module; a selector, with the input end connected to the said module register and the output end of an address line, sets a column address as o or 1 and the output end thereof connected to the input end of the motherboard for utilizing the memory passed the said setting.

9. An address correction and device for a simultaneous dynamic random access memory module according to claim 8, wherein the said selector is a two-to-one multiplexer.
